(19) United States
(12) Patent Application Publication
(10) Pub. No.: US 2025/0005751 A1
(43) Pub. Date: Jan. 2, 2025

(54) MEDICAL DATA PROCESSING APPARATUS, MEDICAL DATA PROCESSING METHOD, AND NON-TRANSITORY COMPUTER READABLE MEDIUM

(71) Applicant: Canon Medical Systems Corporation, Otawara-shi (JP)

(72) Inventors: Shuki MARUYAMA, Nasushiobara (JP); Hidenori TAKESHIMA, Tokyo (JP)

(73) Assignee: Canon Medical Systems Corporation, Otawara-shi (JP)

(21) Appl. No.: 18/751,420

(22) Filed: Jun. 24, 2024

(30) Foreign Application Priority Data
Jun. 30, 2023 (JP) 2023-108349

(51) Int. Cl. G06T 7/00; G06V 10/25

(52) U.S. Cl. CPC G06T 7/0012; G06V 10/25; G06T 2207/10088; G06T 2207/20084

(57) ABSTRACT

According to one embodiment, a medical data processing apparatus includes processing circuitry. The processing circuitry acquires medical data. The processing circuitry generates output data by using a composite function consisting of one or more functions on the medical data, the one or more functions performing arithmetic processing of a fixed coefficient associated with information of interest in the medical data.

### CROSS-REFERENCE TO RELATED APPLICATIONS

This application is based upon and claims the benefit of priority from Japanese Patent Application No. 2023-108349, filed Jun. 30, 2023, the entire contents of which are incorporated herein by reference.

### FIELD

Embodiments described herein relate generally to a medical data processing apparatus, a medical data processing method, and a non-transitory computer readable medium.

### BACKGROUND

There is a method for estimating medical classification based on medical data, such as performing tissue classification of a tumor on a magnetic resonance (MR) image and spectrum data of magnetic resonance spectroscopy (MRS) using a trained model and estimating the grade thereof. However, the inferences made by a trained model used in this method entail a problem in that information relating to a region of interest or an important region is not utilized by the trained model.

### BRIEF DESCRIPTION OF THE DRAWINGS

FIG. 1 is a diagram showing an example of a configuration of a medical data processing apparatus according to an embodiment.

FIG. 2 is a flowchart showing an example of an operation of the medical data processing apparatus according to an embodiment.

FIG. 3 is a diagram showing an input-output relationship of a trained model according to an embodiment.

FIG. 4 is a conceptual diagram showing an MR spectrum as an example of medical data.

FIG. 5 is a diagram showing a first example of a model including an attention layer according to an embodiment.

FIG. 6 is a diagram showing a second example of a model including an attention layer according to an embodiment.

FIG. 7 is a diagram showing a third example of a model including an attention layer according to an embodiment.

FIG. 8 is a diagram showing a fourth example of a model including an attention layer according to an embodiment.

FIG. 9 is a diagram showing a fifth example of a model including an attention layer according to an embodiment.

FIG. 10 is a diagram showing a fifth example of a model including an attention layer according to an embodiment.

FIG. 11 is a diagram showing a sixth example of a model including an attention layer according to an embodiment.

FIG. 12 is a diagram showing a sixth example of a model including an attention layer according to an embodiment.

FIG. 13 is a diagram showing a seventh example of a model including an attention layer according to an embodiment.

FIG. 14 is a diagram showing an eighth example of a model including an attention layer according to an embodiment.

FIG. 15 is a diagram showing a ninth example of a model including an attention layer according to an embodiment.

### DETAILED DESCRIPTION

In general, according to one embodiment, a medical data processing apparatus includes processing circuitry. The processing circuitry acquires medical data. The processing circuitry generates output data by using a composite function consisting of one or more functions on the medical data, the one or more functions performing arithmetic processing of a fixed coefficient associated with information of interest in the medical data.

Hereinafter, embodiments of a medical data processing apparatus, a medical data processing method, and a non-transitory computer readable medium will be described in detail with reference to the accompanying drawings. In the embodiments described below, elements assigned the same reference symbols are assumed to perform the same operations, and redundant descriptions thereof will be omitted as appropriate. Each embodiment will be described below using the drawings.

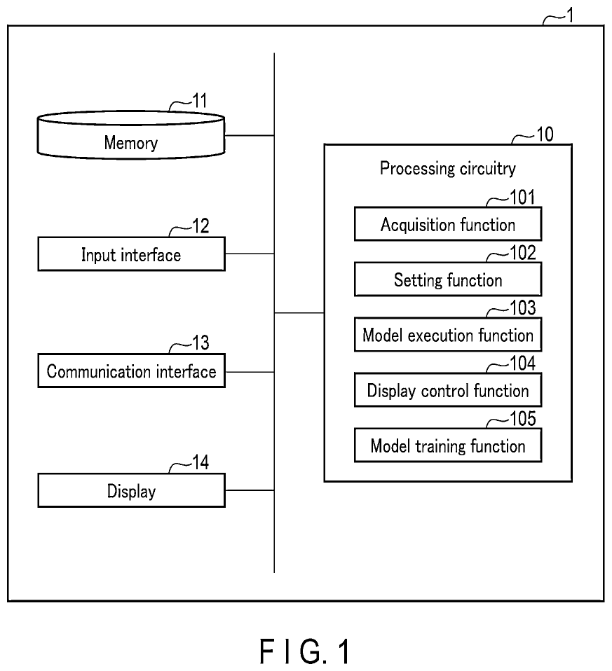

A medical data processing apparatus according to an embodiment will be described with reference to the block diagram of FIG. 1.

As shown in FIG. 1, a medical data processing apparatus 1 is, for example, a computer that has processing circuitry 10, a memory 11, an input interface 12, a communication interface 13, and a display 14. The medical data processing apparatus 1 may be installed in a console of various medical diagnostic imaging apparatuses such as an MRI (magnetic resonance imaging) apparatus and an X-ray CT (computed tomography) apparatus or in a workstation. Alternatively, the medical data processing apparatus 1 may be independent from a medical diagnostic imaging apparatus and a workstation. In addition, the medical data processing apparatus 1 may be realized without including at least one structure among the memory 11, the input interface 12, the communication interface 13, and the display 14. For example, the medical data processing apparatus 1 may be realized by the processing circuitry 10 alone.

The processing circuitry 10 includes a processor as a hardware resource. The processing circuitry 10 functions as the center of the medical data processing apparatus 1.

With an acquisition function 101, the processing circuitry 10 acquires various kinds of medical data. Examples of the various kinds of medical data include MR data such as MR images and MR spectra obtained via MRS (magnetic resonance spectroscopy), medical images typical of nuclear medicine images such as CT images, X-ray images, ultrasonic images, PET (positron emission tomography) images, SPECT (single photon emission computed tomography) images, and intermediate data thereof such as k-space data, projection data, and sinogram data. The medical data may also be other pieces of data relating to examination such as vital data and biopsy data. The medical data may also be time-series data, one-dimensional data such as waveform data and examination data, two-dimensional data such as image data, three-dimensional data such as volume data, or data having more than three dimensions. By implementing the acquisition function 101, the processing circuitry 10 may acquire medical data directly from the medical diagnostic imaging apparatus, or acquire medical data temporarily stored in the memory 11 from the memory 11.

By implementing a setting function 102, the processing circuitry 10 sets, in a composite function, one or more functions for performing arithmetic processing of a fixed coefficient associated with information of interest in the medical data. The information of interest is information indicating an item, a region, or the like that should be paid attention to or is important in the medical data. That is, the information of interest is information that affects the output from the composite function or information that is identified to affect the output from the composite function in the training of the composite function. The fixed coefficient is a real value. In other words, the fixed coefficient is data relating to medical data and a value based on data relating to medical physics or magnetic resonance physics. The composite function is, for example, a model used in machine learning, such as a neural network. Hereinafter, a case where the composite function is a trained model will be described.

With a model execution function 103, the processing circuitry 10 generates output data by using the set composite function. The output data is, for example, a medical classification result relating to medical data. The medical classification result is information relating to, for example, the determination on the presence or absence of a tumor or the grading of a tumor. The output data is not limited to a medical classification result, and may be clinical decision support (CDS) such as segmentation, prognostic estimation, and suggestions of therapeutic methods.

With the display control function 104, the processing circuitry 10 causes various kinds of information to be displayed on the display 14. For example, the medical data, the medical classification result generated by the model execution function 103, etc., are displayed on the display 14.

With a model training function 105, the processing circuitry 10 trains a machine learning model and computes a fixed coefficient relating to the information of interest.

The memory 11 is a storage device such as a hard disk drive (HDD), a solid state drive (SSD), or an integrated circuit storage device, which stores various kinds of information. The memory 11 may be, for example, a drive that reads and writes various kinds of information from and in a portable storage medium such as a CD-ROM drive, a DVD drive, or a flash memory. For example, the memory 11 stores medical data (such as spectrum data, image data, etc.), output data (such as a medical classification result, etc.), control programs, and the like.

The input interface 12 includes an input device that receives various commands from a user. Examples of the input device that can be used include a keyboard, a mouse, various switches, a touch screen, and a touch pad. The input device is not limited to those provided with physical operational components such as a mouse and a keyboard. Examples of the input interface 12 also include electric signal processing circuitry that receives an electric signal corresponding to an input operation through an external input device provided separately from the medical data processing apparatus 1 and outputs the received electric signal to various types of circuitry. The input interface 12 may also be a voice recognition device that receives voice signals via a microphone and converts the voice signals into command signals.

The communication interface 13 is an interface that connects the medical data processing apparatus 1 with a medical diagnostic imaging apparatus, a workstation, a picture archiving and communication system (PACS), a hospital information system (HIS), a radiology information system (RIS), or the like via a local area network (LAN) or the like.

The display 14 displays various kinds of information via the display control function 106. As the display 14, for example, a CRT display, a liquid crystal display, an organic EL display, an LED display, a plasma display, or any other display known in the relevant technical field can be used as appropriate.

The above configuration is merely an example, to which the embodiment is not limited. For example, a storage area of a data collection condition in the memory 11 need not be provided in the medical data processing apparatus 1, and may be provided in a storage device connected to the medical data processing apparatus 1 via a network. Furthermore, each function of the processing circuitry 10 may be implemented through multiple devices. For example, the acquisition function 101, the setting function 102, the model execution function 103, and the display control function 104 may be incorporated into a console of a medical diagnostic imaging apparatus and implemented, and the model training function 105 may be implemented by a workstation. As long as multiple devices can concertedly implement the respective functions of the medical data processing apparatus 1, each processing may be performed by any device.

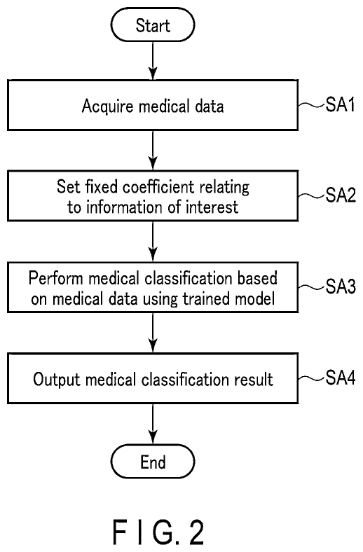

Hereinafter, an example of an operation of the medical data processing apparatus 1 according to an embodiment will be described in detail with reference to the flowchart of FIG. 2.

In step SA1, the processing circuitry 10 acquires medical data by implementing the acquisition function 101.

In step SA2, by implementing the setting function 102, the processing circuitry 10 sets a fixed coefficient associated with information of interest according to the medical data and a task. The fixed coefficient may be set by, for example, incorporating, into a trained model, an attention layer which is a layer structure of a neural network in which a fixed coefficient relating to information of interest is set as a parameter for the trained model.

In step SA3, by implementing the model execution function 103, the processing circuitry 10 applies the trained model into which the attention layer is incorporated to the medical data, whereby output data is generated by the trained model. In other words, arithmetic processing of a fixed coefficient relating to the attention layer is performed on the medical data. In this step, medical classification is performed on the medical data and a medical classification result is obtained.

In step SA4, for example, the processing circuitry 10 outputs the medical classification result to the display 14 or the like by implementing the display control function 104.

If the attention layer is already incorporated into the trained model, a new attention layer need not be set in the trained model in the processing of step SA2.

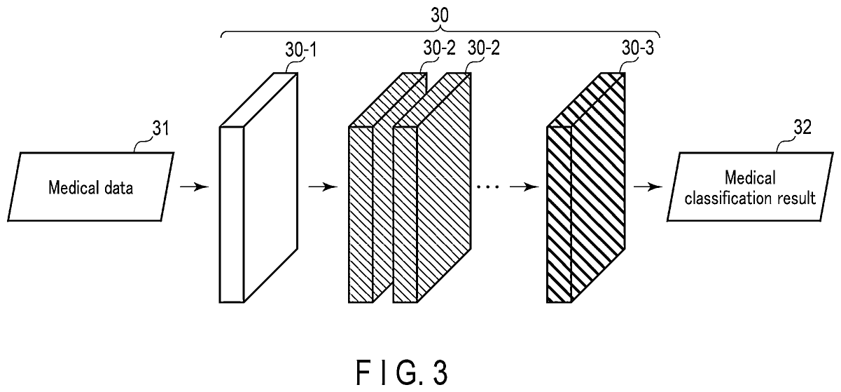

Next, an input-output relationship of the trained model according to an embodiment will be described with reference to FIG. 3.

As shown in FIG. 3, the trained model 30 is a model in which parameters (e.g., a weight and a bias) are trained so that medical data 31 is input thereto and a medical classification result 32 is output therefrom. In this example, the trained model 30 is assumed to be a deep convolutional neural network having a convolutional layer such as Transformer, ResNet, or DenseNet. The trained model 30 is not limited to a deep convolutional neural network and may be any model, provided that it is a composite function (model) used in the field of machine learning.

The trained model 30 includes an input layer, an intermediate layer 30-2, and an output layer 30-3. Herein, the input layer corresponds to an attention layer 30-1. The attention layer 30-1 is a layer for performing arithmetic processing of a fixed coefficient relating to information of interest such as molecular information that one wishes to pay attention to, a region that one wishes to pay attention to, and the like. The attention layer 30-1 is formed of, for example, a full connection (FC) layer, and the medical data 31 is multiplied by a fixed coefficient. That is, the attention layer 30-1 acts to perform processing dependent on the positional information of the medical data 31.

On the other hand, the intermediate layer 30-2 is assumed to be a layer in which a plurality of convolutional layers are arranged. Thus, in the intermediate layer 30-2, if the receptive fields of the convolutional layers are considered, processing not dependent on the positional information is performed as the network becomes deeper.

The output layer 30-3 outputs, for example, a probability value relating to a classification task as a medical classification result.

Next, an MR spectrum as an example of medical

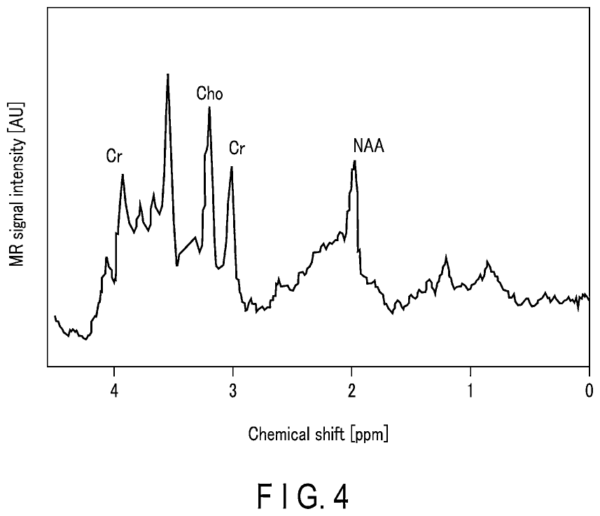

data according to an embodiment will be described with reference to the conceptual diagram of FIG. 4.

The MR spectrum shown in FIG. 4 is a spectrum based on data obtained by MRS, which is a type of chemical shift measurement. MRS is a data collection method for measuring a spectrum of a chemical shift. The method adopted is not limited to MRS, and spectrum data obtained by any measurement method such as CSI (chemical shift imaging), CEST (chemical exchange spectroscopy), ZAPPED (Z-spectrum analysis provides proton environment data), diffusion-weighted MRS, etc., may be used as the medical data of the present embodiment. The diffusion-weighted MRS is MRS using pulse sequences with a diffusion-weighted gradient field (MPG: motion probing gradient), and in an obtained spectrum, diffusion of hydrogen nuclei in a molecule is weighted by the application of an MPG.

As a method of generating spectrum data, specifically, k-space data corresponding to a cumulated number and that is collected based on the pulse sequences of MRS using PRESS (point resolved spectroscopy), STEAM (stimulated echo acquisition mode), ISIS (image-selected in vivo spectroscopy), SPECIAL (spin echo full intensity acquired localized), semi-LASER (semi-localization by adiabatic selective refocusing), LASER, etc., is synthesized. MRS spectrum data may be generated by subjecting the synthesized k-space data to Fourier transformation, transforming an MR signal intensity value into digital data represented by a frequency function, and subjecting the digital data obtained after the transformation to post-processing such as phase correction, baseline correction, etc.

In the MR spectrum shown in FIG. 4, the vertical axis is defined by an MR signal intensity value [AU (Arbitrary Unit)], and the horizontal axis is defined by a difference from a reference frequency, that is, a chemical shift [ppm (parts per million)]. The reference frequency is set to a frequency of a discretionarily selected reference substance. The reference substance is not particularly limited but is set to, for example, tetramethylsilane (TMS). According to the MR spectrum, the abundance of molecules, such as N-acetylaspartate (NAA), creatine (Cr), choline (Cho), etc., can be visualized.

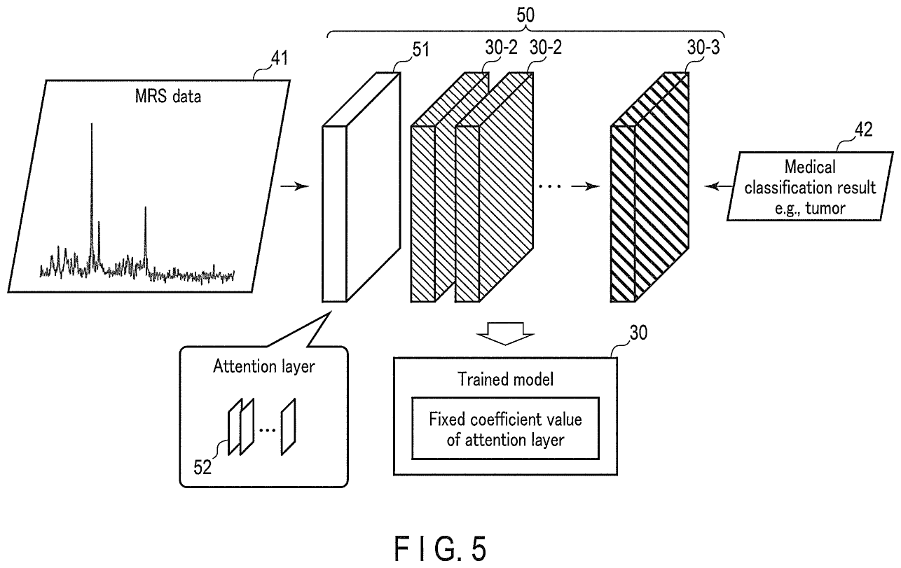

Next, a first example of a model including an attention layer according to an embodiment will be described with reference to FIG. 5.

If a molecule as information of interest is unknown, the processing circuitry 10 may train a machine learning model 50 by implementing the model training function 105 and thereby generate the trained model 30.

As the training data, a combination of medical data (herein, MRS data 41 as an example) as input data and medical classification results 42 collected from past instances as correct data may be used. The MRS data 41 as input data is generated, for example, by an MRI apparatus. As the medical classification result 42 as correct data, a classification result determined by a medical staff member using the MRS data 41, biopsy data relating to the same subject as that of the MRS data 41, or medical information such as an MR image can be used. The grade may be determined according to a predetermined algorithm using a computer based on the input data or medical information.

By implementing the setting function 102, the processing circuitry 10 incorporates an attention layer 51 into a machine learning model to be trained. The attention layer 51 may be set so as to include the number of channels 52 corresponding to the type of information of interest. Specifically, if there are three types of molecules as information of interest, for example, the number of channels 52 of the attention layer 51 may be set to three.

Thereafter, by implementing the model training function 105, the processing circuitry 10 performs a forward propagation process by applying the machine learning model 50 to the MRS data 41 as input data and outputs a medical classification result (hereinafter referred to as an estimated medical classification result). Next, by implementing the model training function 105, the processing circuitry 10 computes a difference (error) between the estimated medical classification result and the medical classification result 42 as correct data using an error function, and updates the parameters of the machine learning model 50 through a back propagation method and a stochastic gradient descent method so that the error will be minimal. As the error function, a function used according to the tasks of the machine learning model, such as mean squared error (MSE), cross entropy, etc., may be determined.

By implementing the model training function 105, the processing circuitry 10 determines whether or not training is completed. With regard to the determination on whether or not training is completed, it may be determined that training is completed, for example, if an error value computed by an error function is equal to or below a threshold. Alternatively, it may be determined that training is completed if the reduction in the error value falls within a predetermined value. Furthermore, it may be determined that training is completed if training with a predetermined number of epochs is completed. If training is completed, the trained model 30 is generated by allocating a determined parameter to the machine learning model.

Thus, a fixed coefficient of each channel of the attention layer 51 corresponding to information of interest can be computed. Thereafter, processing may be performed so as to output a medical classification result for new MRS data 41.

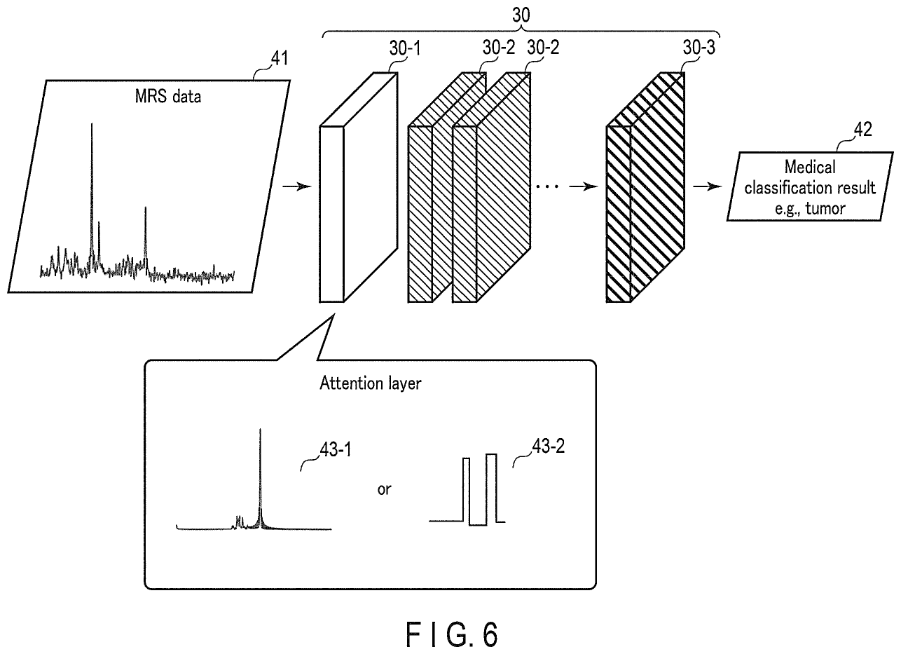

Next, a second example of a model including an attention layer according to an embodiment will be described with reference to FIG. 6.

As shown in FIG. 6, the trained model 30 is a model in which parameters are trained so that the MRS data 41 indicating an MR spectrum is input thereto as medical data and the medical classification result 42 indicating tissue characterization of a region of interest is output therefrom. The MRS data 41 is assumed to be intermediate data in the process of, for example, generating the spectrum shown in FIG. 4 or an MR spectrum.

Information of interest, or, in this example, a layer for multiplying medical data by a fixed coefficient relating to a single spectrum of a molecule that one wishes to pay attention to in the MRS, is introduced into an attention layer 30-1 according to the embodiment. That is, the fixed coefficient is assumed to be a base spectrum or a spectrum corresponding to a chemical shift of a molecule. The single spectrum may be simulation data 43-1 or data artificially generated through machine learning, etc., data obtained by imaging a phantom, rectangular waveform data 43-2 corresponding to a chemical shift value of each peak of the spectra thereof, or data corresponding to a chemical shift value of a specific peak. When the MRS data 41 is input into the attention layer 30-1, a region corresponding to data relating to a spectrum of a molecule that one wishes to pay attention to is processed while being weighted in the intermediate layer 30-2 (one or more convolutional layers) in the later stage. That is, it can be said that a convolutional process is performed while taking into consideration whether the shape of the single spectrum of the molecule that one wishes to pay attention to is included in the MR spectrum or not.

The medical classification result 42 is output from the output layer 30-3 of the trained model 30, and, for example, the presence or absence of a tumor of a subject P is output. Specifically, in the example shown in FIG. 6, an indication “tumor” is output as the medical classification result 42. The form of output is not particularly limited; a multiclass classification may be used that outputs a grade with a high probability with which the subject P belongs as a value close to “1” and outputs a grade with a low probability as a value close to “0”, among multiple grades, in addition to the presence or absence of a tumor. Also, the presence or absence of a cancer metastasis, a probability of applying to a case, or the like may be output as the medical classification result 42.

The presence or absence of an IDH1 mutation (isocitrate dehydrogenase-1 mutation) may be output as the medical classification result 42. An IDH1 variant is known to produce 2-HG (2-hydroxyglutarate) (see, for example, Jelena Lazovic et al., “Detection of 2-hydroxyglutaric acid in vivo by proton magnetic resonance spectroscopy in U87 glioma cells overexpressing isocitrate dehydrogenase-1 mutation” Neuro-Oncology 14(12): 1465-1472, 2012). That is, there is a correlation between the presence of 2-HG and the mutation of IDH1.

2-HG can be detected by the MRS and may form a peak in an MR spectrum. Also, 2-HG can be drawn in MR morphological images such as a T2-weighted image and a FLAIR image. By setting a fixed coefficient for a spectrum relating to 2-HG in the attention layer 30-1, it is also possible to output the medical classification result 42 for a grade representing the presence or absence of IDH1 mutation and the degree of the mutation.

The MRS data input to the trained model 30 is not limited to the waveform data of the MR spectrum shown in FIG. 6. For example, the MRS data may be a combination of numerical data of a chemical shift value of each peak of the MR spectrum and an MR signal intensity value (peak value) or a combination of numerical data of a chemical shift value and an MR signal intensity value (peak value) peak width (half width). The MRS data may also be a combination of numerical data of an identifier (name and symbol) of a molecule relating to each peak of the MR spectrum and an MR signal intensity value, a combination of numerical data of an identifier of a molecule, an MR signal intensity value, and a half width, or an estimated value of the concentration of a molecule or a relative value thereof. In addition, any intermediate product obtained in the process of generating MRS data may be input to the trained model 30. For example, k-space data before addition, k-space data after addition, or k-space data after Fourier transformation may be input to the trained model 30. The aforementioned MR spectrum and intermediate products of the MR spectrum are examples of the MRS data.

A fixed coefficient of the attention layer 30-1 in the case where the MRS data is not waveform data of an MR spectrum may be set according to the data format input to the attention layer 30-1. For example, if the MRS data is a combination of a chemical shift value and an MR signal intensity value, a value relating to the chemical shift value of a molecule of interest, which is information of interest, and the MR signal intensity value may be set as a fixed coefficient in the attention layer 30-1. As explained, even if the MRS data has other data formats, a fixed coefficient may be set in the same manner.

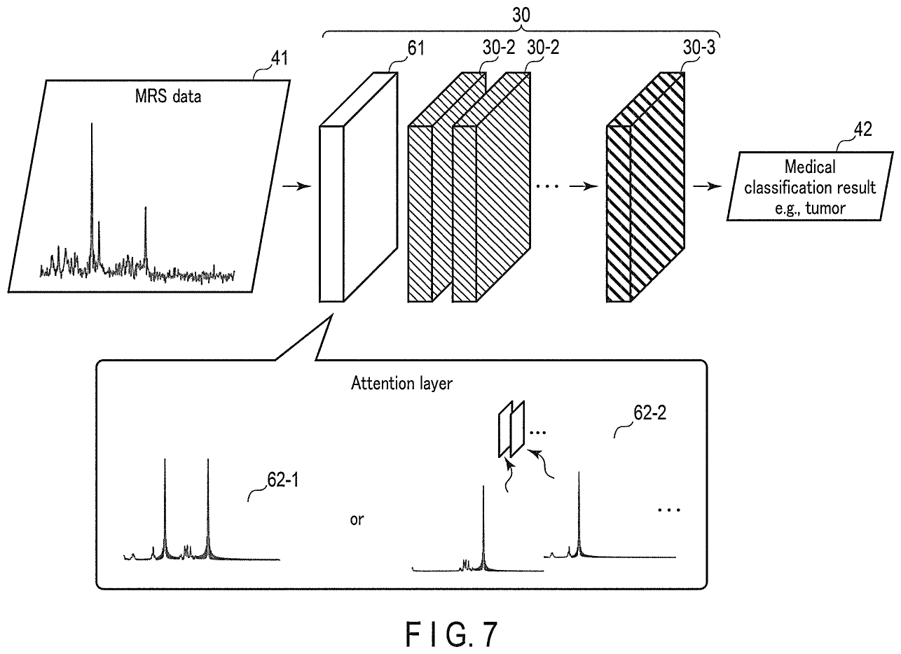

A third example of a model including an attention layer according to an embodiment will be described with reference to FIG. 7.

The configuration of an attention layer 61 makes the model shown in FIG. 7 different from the model shown in FIG. 6. The attention layer 61 shown in FIG. 7 is assumed to be set in the case where there are multiple molecules that one wishes to pay attention to, which becomes information of interest. For example, a synthetic spectrum 62-1 of the molecules that one wishes to pay attention to may be generated by synthesizing single spectra of multiple molecules, and a layer for multiplying medical data by a fixed coefficient relating to the synthetic spectrum 62-1 may be introduced. Alternatively, a fixed coefficient corresponding to each single spectrum may be set as a channel 62-2. Since a product sum of the MRS data 41 and the channel 62-2 is calculated in the attention layer 61, a fixed coefficient relating to a plurality of single spectra may be used in the attention layer as in the synthetic spectrum 62-1.

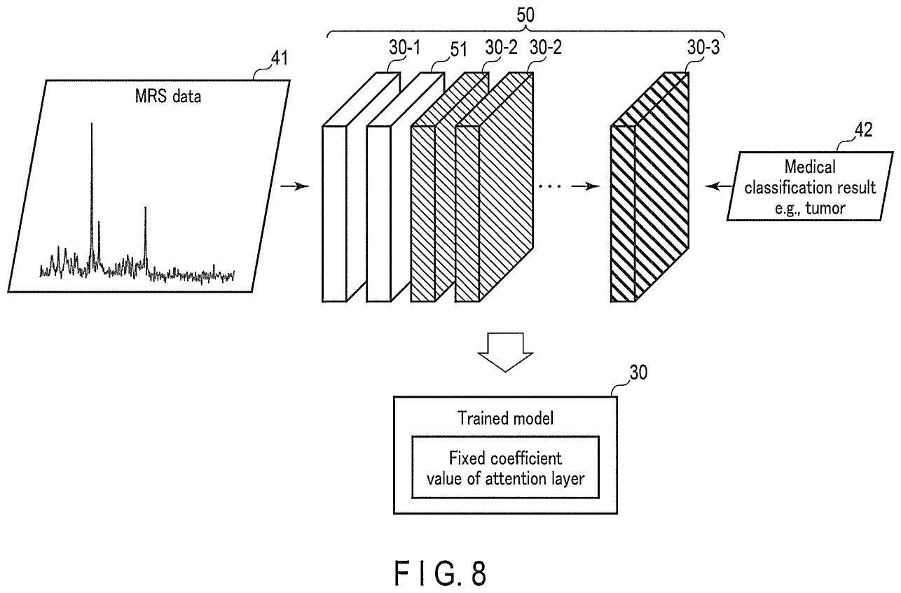

Next, a fourth example of a model including an attention layer according to an embodiment will be described with reference to FIG. 8.

FIG. 8 shows an example in which the case where information of interest is known and the case where information of interest is unknown are combined. Namely, the machine learning model 50 includes the attention layer 30-1 relating to known information of interest and the attention layer 51 relating to unknown information of interest. In the example shown in FIG. 8, through the training of the machine learning model 50 including the attention layer 30-1 and the attention layer 51, a fixed coefficient corresponding to a single spectrum of a known molecule and a fixed coefficient corresponding to one or more channels of a single spectrum of an unknown molecule are computed. The machine learning model 50 may be trained by the same method as the method shown in FIG. 5.

Thus, a fixed coefficient corresponding to a single spectrum can be generated for unknown molecules other than the known molecules.

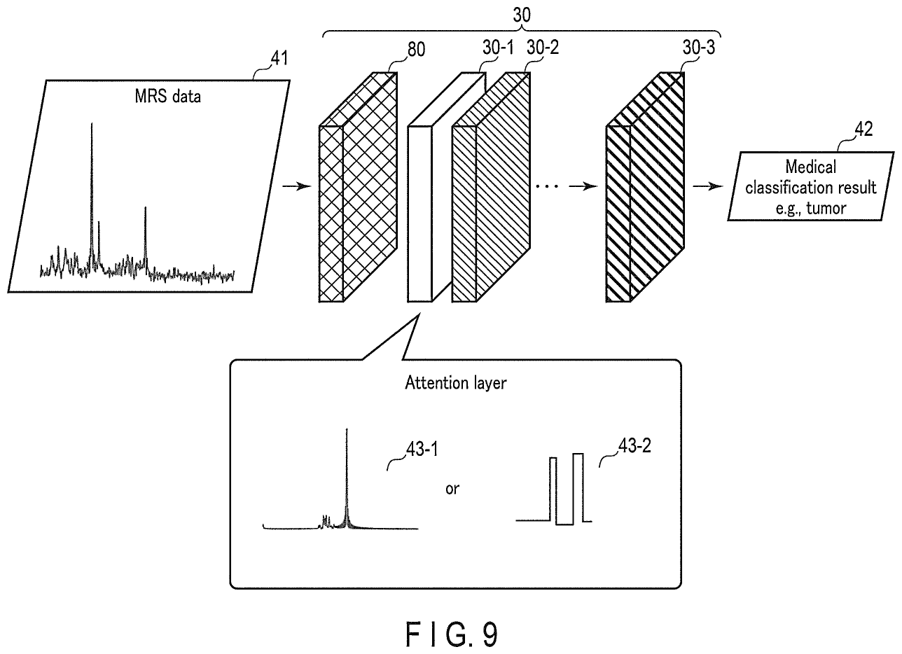

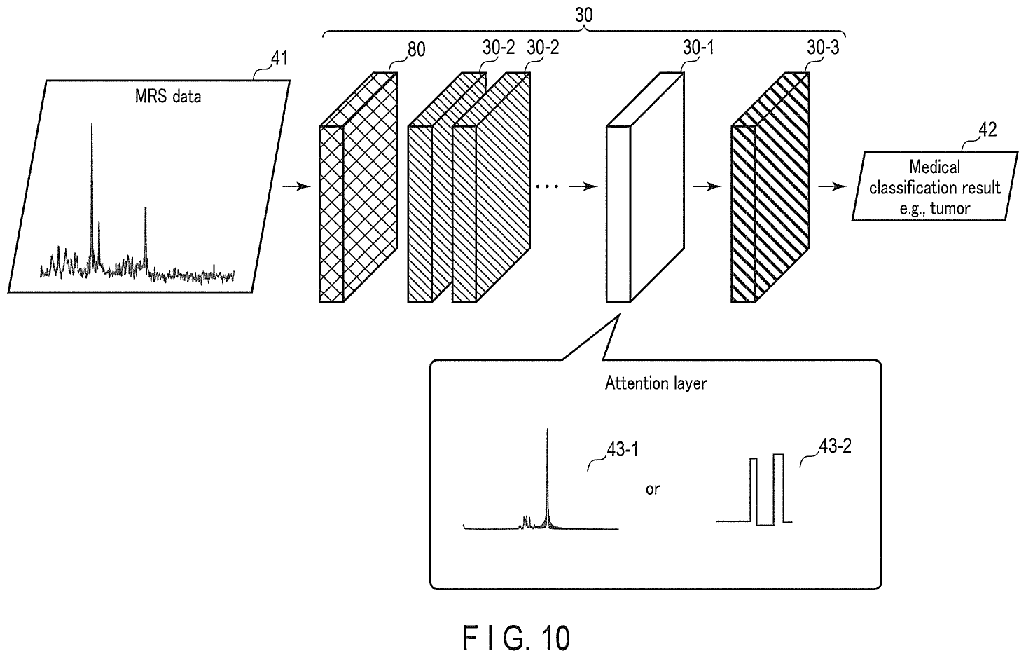

Next, a fifth example of a model including an attention layer according to an embodiment will be described with reference to FIGS. 9 and 10.

In the examples shown in FIGS. 5 to 8, the attention layer 30-1 is incorporated in the position of the input layer of the trained model 30 or the machine learning model 50; however, an embodiment is not limited thereto. The attention layer 30-1 may be incorporated in any position in the trained model 30 or the machine learning model 50 except in the position of the output layer 30-3.

FIG. 9 shows an example in which the attention layer 30-1 is arranged after an input layer 80 in the trained model 30. FIG. 10 shows an example in which the attention layer 30-1 is arranged at the end of the intermediate layer, that is, arranged before the output layer 30-3. In this manner, the attention layer 30-1 may be arranged in any position. A fixed coefficient of the attention layer 30-1 may be adjusted according to the size of the output from the previous layer (the input layer 80 or the intermediate layer 30-2) since the size of the data input to the attention layer 30-1 varies depending on the depth of the network.

Next, a sixth example of a model including an

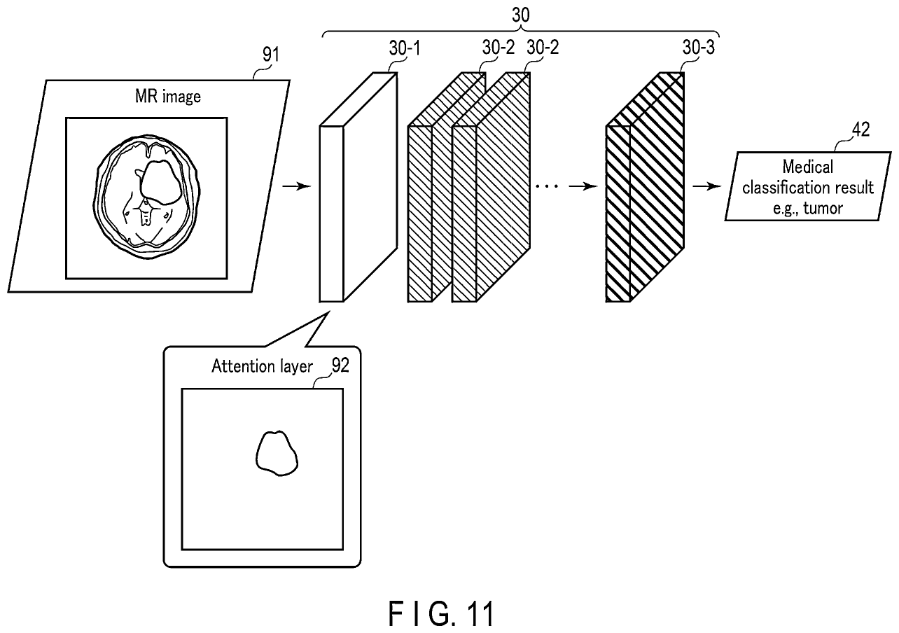

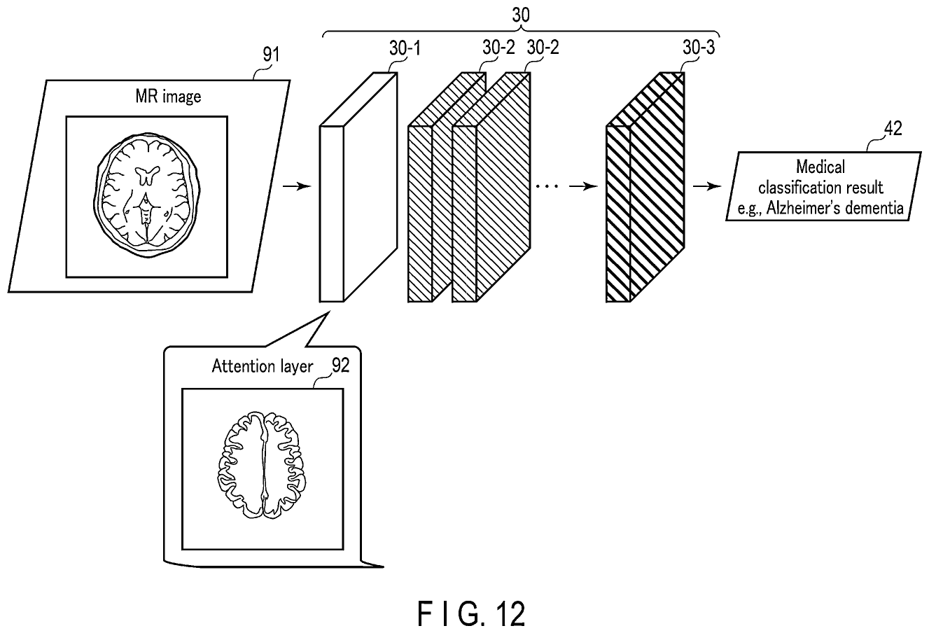

attention layer according to an embodiment will be described with reference to FIGS. 11 and 12.

In FIG. 11, medical data that is input is assumed to be two-dimensional data, that is, a medical image. For example, a fixed coefficient corresponding to mask data, weighted data, segmentation data, and annotation data, which are data relating to medical physics, is set in the attention layer 30-1 relating to a medical image. In the example shown in FIG. 11, the trained model 30 is applied to an MR image 91, and, for example, a fixed coefficient corresponding to mask data 92 having a tumor part as a region of interest (ROI) is set in the attention layer 30-1. The MR image is assumed to be a T1-weighted image, a T2-weighted image, a T2*-weighted image, a FLAIR (fluid attenuated inversion recovery) image, an MR angiography, a diffusion-weighted image, or an image collected by other imaging methods. Thus, inferences are made on the MR image 91 based on the region set by the mask data.

A fixed coefficient of the attention layer 30-1 relating to a tumor region may be set for an input MR image so as to correspond to a manually generated mask region. Alternatively, mask data may be generated from annotated segmentation data using U-net, etc., and a corresponding fixed coefficient may be obtained. A fixed coefficient may be expressed by, for example, a weight in which an ROI region as information of interest is 1 and the other regions are 0. A fixed coefficient need not necessarily be set with a binary weight of 0 or 1. A fixed coefficient may be set by allocating a value from 0 to 1 as a weight to multiple tissues. For example, in the case of a mask region targeting a tumor, a fixed coefficient may be set by allocating a weight in which the substance is “0.1”, the edema is “0.8”, and the entire tumor is “1”.

Next, FIG. 12 is an example of using, as a parameter, a fixed coefficient, in other words, segmentation data, corresponding to mask data of the attention layer 30-1 relating to brain gray matter. Thus, inferences are made based on the region set by the mask data when the trained model 30 is applied to the MR image 91. As the medical classification result 42, for example, a classification indicating Alzheimer's dementia is made.

A fixed coefficient of the attention layer 30-1 relating to brain gray matter shown in FIG. 12 may be set in an input MR image so as to correspond to a manually generated mask region. Alternatively, mask data may be generated from segmentation data relating to brain gray matter based on a signal intensity and positional information corresponding to the brain gray matter by using U-net, etc., and a corresponding fixed coefficient may be obtained.

A mask of brain gray matter need not necessarily be used herein. The attention layer 30-1 may be set using mask data relating to a tissue such as white matter, cerebrospinal fluid (CSF), or the like. Furthermore, mask data combining a plurality of tissue regions, such as mask data of a brain gray matter region and a CSF region, may be formed, and a corresponding fixed coefficient may be set in the attention layer 30-1.

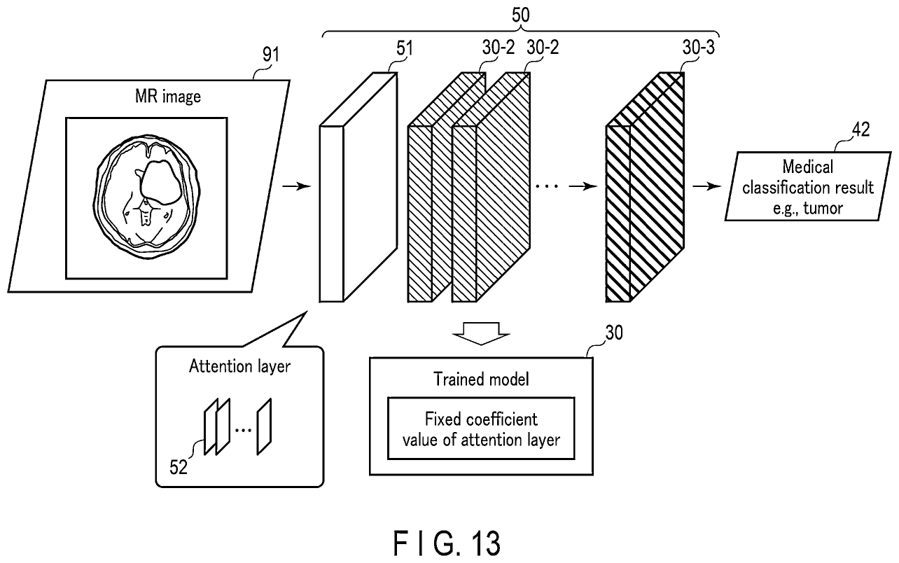

Next, a seventh example of a model including an attention layer according to an embodiment will be described with reference to FIG. 13.

As in the case where medical data is MRS data, if a mask region as information of interest is unknown, the processing circuitry 10 may train a machine learning model 50 by implementing the model training function 105 and thereby generate the trained model 30.

As the training data, a combination of the MR image 91 as input data and the medical classification results 42 collected from past instances as correct data may be used. The MR image 91 as input data is generated, for example, by an MRI apparatus. As the medical classification result 42 as correct data, a classification result may be used that is determined by medical staff using the MR image 91, biopsy data relating to the same subject as that of the MR image 91, or medical information such as an MR image. The grade may be determined according to a predetermined algorithm using a computer based on the input data or medical information.

By implementing the setting function 102, the processing circuitry 10 incorporates an attention layer 51 into a machine learning model to be trained. The attention layer 51 may be set so as to include the number of channels 52 corresponding to the type of information of interest. Specifically, if there are three types of mask regions as information of interest, for example, the number of channels 52 of the attention layer 51 may be set to three.

Thereafter, by implementing the model training function 105, the processing circuitry 10 performs a forward propagation process by applying the machine learning model 50 to the MR image 91 as input data and outputs an estimated medical classification result, as in the case shown in FIG. 5. Next, by implementing the model training function 105, the processing circuitry 10 computes a difference (error) between the estimated medical classification result and the medical classification result 42 as correct data using an error function, and updates the parameters of the machine learning model 50 through a back propagation method and a stochastic gradient descent method so that the error will be minimal. Upon completion of the training, the trained model 30 is generated.

Thus, a fixed coefficient of each channel of the attention layer 51 corresponding to information of interest can be computed. Thereafter, processing may be performed so as to output a medical classification result to new MRS data 41.

Not only the MR image 91 collected by an MRI apparatus but also medical images collected by other medical diagnostic imaging apparatuses can also realize the same function. For example, even if a CT image captured by an X-ray CT apparatus or a material discrimination image captured by a dual energy CT apparatus or a photon counting CT apparatus is input, a fixed coefficient of the attention layer 30-1 may also be set, for example, by the mask data 92 of a region of interest.

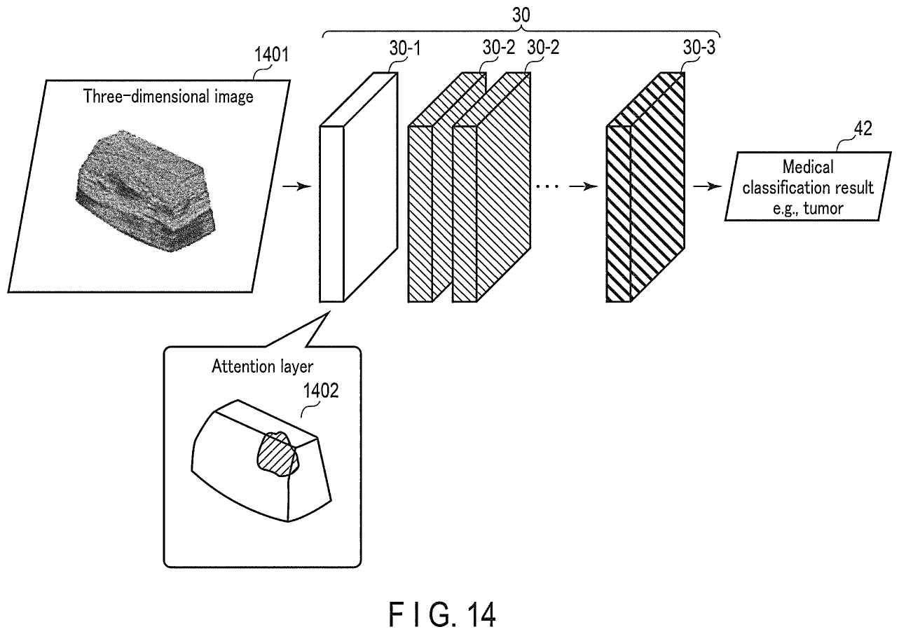

Next, an eighth example of a model including an attention layer according to an embodiment will be described with reference to FIG. 14.

In FIG. 14, medical data that is input is assumed to be three-dimensional data of ultrasonic data, that is, volume data 1401. For example, the attention layer 30-1 relating to the volume data 1401 includes, as a parameter, a fixed coefficient corresponding to mask data, segmentation data, and annotation data for the volume data. In the example shown in FIG. 13, the trained model 30 is applied to the volume data 1401. For example, mask data 1402 for the volume data having a tumor part as a region of interest (voxel of interest) is set in the attention layer 30-1 of the trained model 30. Thus, inferences are made on the volume data 1401 based on the region set by the mask data, as in the case of the two-dimensional images shown in FIGS. 11 and 12.

As described above, any of the first to fifth working examples of the models shown in FIGS. 3 to 10 can be applied to any medical data. That is, for a medical image such as the MR image 91 and the volume data 1401, for example, the attention layer 30-1 relating to known information of interest and the attention layer 51 relating to unknown information of interest may also be combined to train a model, or the position in a model into which the attention layer 30-1 is incorporated may be freely changed.

In the examples shown above, a fixed coefficient is assumed to be mask data, segmentation data, etc., relating to a molecule of interest and a region of interest; however, the embodiment is not limited thereto. It may be a value based on a parameter relating to the imaging performed by a medical diagnostic imaging apparatus that has collected medical data. For example, if the medical diagnostic imaging apparatus is an MRI apparatus, a fixed coefficient may be a value corresponding to data concerning magnetic field inhomogeneity relating to magnetic resonance physics, or transmission sensitivity data and reception sensitivity data of a coil of the MRI apparatus.

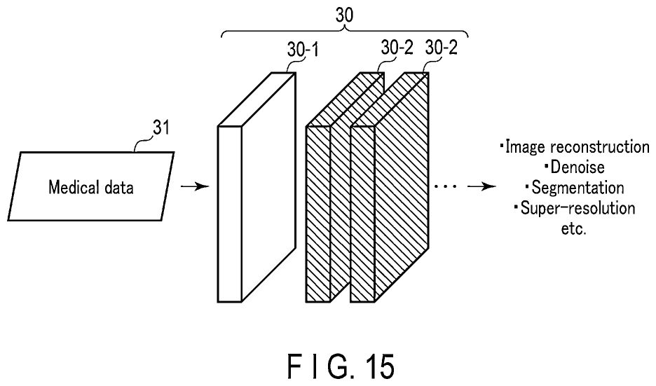

Next, a ninth example of a model including an attention layer according to an embodiment will be described with reference to FIG. 15.

As shown in FIG. 15, it is also possible to apply a layer structure of a trained model excluding the output layer 30-3 from the trained model to a method other than a classification task. For example, by arranging a processing layer (e.g., a decoder) for performing upsampling as an output layer or using a network such as U-net, it is possible to perform image reconstruction using a layer structure including the attention layer 30-1. Alternatively, the layer structure may be applied to denoising processing, segmentation processing, super-resolution processing, etc., performed on an image. That is, switching the configuration of the output layer 30-3 for the trained model including the attention layer 30-1 of the embodiment, that is, switching the so-called head, allows for application to multiple tasks, allowing a desired task to be processed.

According to the embodiment described above, a result of an inference such as a medical classification result is generated as output data by using a composite function such as a machine learning model or a trained model having one or more functions for performing arithmetic processing of a fixed coefficient associated with information of interest on medical data. Thus, in an inference using a trained model, for example, medical data is multiplied by a fixed coefficient relating to an important region, whereby information relating to the important region is incorporated, and an inference focused on the important region is performed. That is, the accuracy of the model can be enhanced.

According to at least one embodiment described above, it is possible to enhance the accuracy of the medical classification made using medical data.

The term “processor” used in the above description means, for example, a CPU, a GPU, or circuitry such as an application specific integrated circuit (ASIC, a programmable logic device (e.g., a simple programmable logic device (SPLD), a complex programmable logic device (CPLD), or a field programmable gate array (FPGA)). The processor implements a function by reading and executing a program stored in storage circuitry. The program may be directly incorporated into the circuit of the processor instead of being stored in the storage circuit. In this case, the processor implements the function by reading and executing the program incorporated into the circuit. The function corresponding to the program may be realized by a combination of logic circuits, not by executing the program. Each processor of the present embodiment is not limited to being configured as a single circuit; a plurality of independent circuits may be combined to form a single processor and implement the functions of the processor. Furthermore, multiple components may be integrated into a single processor to implement the functions of the processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical data processing apparatus comprising processing circuitry configured to:
acquire medical data; and
generate output data by using a composite function consisting of one or more functions on the medical data, the one or more functions performing arithmetic processing of a fixed coefficient associated with information of interest in the medical data.

2. The medical data processing apparatus according to claim 1, wherein the information of interest is information in the medical data that affects output from the composite function or information in the medical data that is identified to affect output from the composite function during training of the composite function.

3. The medical data processing apparatus according to claim 1, wherein in the composite function, the medical data is multiplied by the fixed coefficient as the arithmetic processing.

4. The medical data processing apparatus according to claim 1, wherein the fixed coefficient is data relating to the medical data and a value based on data relating to medical physics or magnetic resonance physics.

5. The medical data processing apparatus according to claim 1, wherein the medical data is at least one of MR (magnetic resonance) data, CT (computed tomography) data, ultrasonic data, PET (positron emission tomography) data, SPECT (single photon emission computed tomography) data, vital data, or biopsy data.

6. The medical data processing apparatus according to claim 1, wherein the medical data is at least one of time-series data, image data, waveform data, examination data, or data having three or more dimensions.

7. The medical data processing apparatus according to claim 1, wherein
the medical data is MRS data, and
the fixed coefficient is a base spectrum or a spectrum corresponding to a chemical shift of a molecule.

8. The medical data processing apparatus according to claim 1, wherein
the medical data is MRS data, and
the composite function performs, on the MRS data, arithmetic processing of the fixed coefficient relating to molecular information in which a user is interested.

9. The medical data processing apparatus according to claim 1, wherein
the medical data is MRS data, and
the composite function is trained by training data, whereby the fixed coefficient relating to unknown molecular information is set for the MRS data.

10. The medical data processing apparatus according to claim 1, wherein
the medical data is an MR image, and
the composite function performs, on the MR image, the arithmetic processing of the fixed coefficient relating to a region of interest of an image.

11. The medical data processing apparatus according to claim 1, wherein
the medical data is an MR image, and
the composite function is trained by training data, whereby the fixed coefficient relating to extraction of an unknown image region is set for the MR image.

12. The medical data processing apparatus according to claim 1, wherein
the composite function is a neural network, and
a function for performing the arithmetic processing of the fixed coefficient is a layer of the neural network that includes the fixed coefficient as a parameter.

13. The medical data processing apparatus according to claim 12, wherein
the medical data is MRS data, and
if there are multiple pieces of molecular information in which a user is interested in the MRS data, the fixed coefficient relating to composite data of the multiple pieces of molecular information is set in the layer, or the fixed coefficient corresponding to each of the pieces of molecular information is set in each channel in the layer.

14. The medical data processing apparatus according to claim 12, wherein
the medical data is an MR image, and
if there are a plurality of image regions in which a user is interested in the MR image, the fixed coefficient relating to composite data of the plurality of image regions is set in the layer, or the fixed coefficient corresponding to each of the image regions is set in each channel in the layer.

15. The medical data processing apparatus according to claim 1, wherein
the composite function is a neural network, and
a configuration of an output layer of the neural network is switched, whereby the output data is applied to multiple tasks.

16. The medical data processing apparatus according to claim 1, wherein the output data is a result of any of medical classification processing, image reconstruction processing, denoising processing, segmentation processing, or super-resolution processing performed on the medical data.

17. The medical data processing apparatus according to claim 1, wherein the fixed coefficient is a value corresponding to data relating to magnetic field inhomogeneity of an MRI (magnetic resonance imaging) apparatus that has collected the medical data or a value corresponding to transmission and reception sensitivity data of a coil.

18. A medical data processing method comprising:
acquiring medical data; and
generating output data by using a composite function consisting of one or more functions on the medical data, the one or more functions performing arithmetic processing of a fixed coefficient associated with information of interest in the medical data.

19. A non-transitory computer readable medium including computer executable instructions, wherein the instructions, when executed by a processor, cause the processor to perform a method comprising:
acquiring medical data; and
generating output data by using a composite function consisting of one or more functions on the medical data, the one or more functions performing arithmetic processing of a fixed coefficient associated with information of interest in the medical data.
